(19) United States
(12) Patent Application Publication
(10) Pub. No.: US 2026/0133053 A1
(43) Pub. Date: May 14, 2026

(54) SYSTEMS AND METHODS FOR MONITORING AND RECALIBRATING INFRASTRUCTURE AND VEHICLE SENSORS

(71) Applicant: Ford Global Technologies, LLC, Dearborn, MI (US)

(72) Inventors: Brendan Diamond, Naples, FL (US); Vyas Darshan Shenoy, Canton, MI (US); Stuart C. Salter, White Lake, MI (US); Krishna Bandi, Novi, MI (US); Mario Anthony Santillo, Canton, MI (US)

(73) Assignee: Ford Global Technologies, LLC, Dearborn, MI (US)

(21) Appl. No.: 18/945,178

(22) Filed: Nov. 12, 2024

(51) Int. Cl. G01C 25/00; B62D 65/18; G01C 21/28

(52) U.S. Cl. CPC G01C 25/00; G01C 21/28; B62D 65/18

(57) ABSTRACT

A method includes the identification of a current trajectory of an automated vehicle based on a movement of the automated vehicle through a marshaling environment, the calculation of a distance-based differential between the current trajectory of the automated vehicle and an expected trajectory of the automated vehicle, the determination of whether the distance-based differential exceeds a variation threshold, and the recalibration of one or more sensors of an infrastructure system in response to the distance-based differential exceeding the variation threshold.

### FIELD

The present disclosure relates to identifying issues associated with an infrastructure sensor suite and/or a vehicle sensor suite. More particularly, the present disclosure relates to identifying the issues and recalibrating sensor(s) of the infrastructure sensor suite and/or the vehicle sensor suite based on the identification of the issues.

### BACKGROUND

The statements in this section merely provide background information related to the present disclosure and may not constitute prior art.

Infrastructure-guided marshaling of one or more vehicles in a marshaling environment typically rely on a communication between a sensor suite associated with the infrastructure and a sensor suite associated with each vehicle of the one or more vehicles. However, the communication may be unreliable in some instances, which can result in inefficiencies in a marshaling process. For example, it is time-consuming and often difficult to identify such communication issues and thus potential recalibration of the infrastructure sensor suite and/or the vehicle sensor suite occurs too late in the marshaling process due to the late identification. The present disclosure addresses these and other issues related to the identification and/or recalibration of the infrastructure sensor suite and/or the vehicle sensor suite.

### SUMMARY

This section provides a general summary of the disclosure and is not a comprehensive disclosure of its full scope or all of its features.

The present disclosure provides a method comprising: identifying a current trajectory of an automated vehicle based on a movement of the automated vehicle through a marshaling environment, wherein the current trajectory is based on a current location of the automated vehicle and a current speed of the automated vehicle; calculating a distance-based differential between the current trajectory of the automated vehicle and an expected trajectory of the automated vehicle, wherein the expected vehicle trajectory is based on a target path and a target vehicle speed; determining whether the distance-based differential exceeds a variation threshold; and recalibrating one or more sensors of an infrastructure system in response to the distance-based differential exceeding the variation threshold, wherein the recalibration of the one or more sensors is based on a vehicle perception analysis; further comprising: causing one or more sensors of the automated vehicle to be recalibrated in response to the distance-based differential exceeding the variation threshold; wherein the recalibration of the one or more sensors of the infrastructure system or the one or more sensors of the automated vehicle includes an intrinsic calibration, an extrinsic calibration, a color calibration, a frequency calibration, an angle calibration, a power calibration, or a combination thereof; wherein the vehicle perception analysis includes a field of vision analysis, a power analysis, a signal strength of reflected beams, an identification of one or more objects, distance measurements, detection accuracy, or a combination thereof; further comprising: transmitting, to the automated vehicle, one or more instructions in response to the distance-based differential satisfying the variation threshold; and causing the automated vehicle to move from one workstation of the marshaling environment to another workstation of the marshaling environment based on the one or more instructions; further comprising: aggregating a distance-based differential for each automated vehicle of a plurality of automated vehicles; generating a statistical distribution of an expected trajectory of each automated vehicle of the plurality of automated vehicles based on the aggregated distance-based differentials; and determining whether the distance-based differential exceeds the variation threshold for each automated vehicle of the plurality of automated vehicles based on the statistical distribution; and further comprising: transmitting an alert in response to an unsuccessful recalibration of the one or more sensors, wherein the alert is a service request.

The present disclosure provides a system comprising: an infrastructure system configured to: identify a current trajectory of an automated vehicle based on a movement of the automated vehicle through a marshaling environment, wherein the current trajectory is based on a current location of the automated vehicle and a current speed of the automated vehicle, calculate a distance-based differential between the current trajectory of the automated vehicle and an expected trajectory of the automated vehicle, wherein the expected vehicle trajectory is based on a target path and a target vehicle speed, determine whether the distance-based differential exceeds a variation threshold, and recalibrate one or more sensors of the infrastructure system in response to the distance-based differential exceeding the variation threshold, wherein the recalibration of the one or more sensors is based on a vehicle perception analysis; and the automated vehicle configured to: recalibrate one or more sensors of the automated vehicle in response to the distance-based differential exceeding the variation threshold; wherein the recalibration of the one or more sensors of the infrastructure system or the one or more sensors of the automated vehicle includes an intrinsic calibration, an extrinsic calibration, a color calibration, a frequency calibration, an angle calibration, a power calibration, or a combination thereof; wherein the vehicle perception analysis includes a field of vision analysis, a power analysis, a signal strength of reflected beams, an identification of one or more objects, distance measurements, detection accuracy, or a combination thereof; wherein the infrastructure system is further configured to: transmit, to the automated vehicle, one or more instructions in response to the distance-based differential satisfying the variation threshold; and cause the automated vehicle to move from one workstation of the marshaling environment to another workstation of the marshaling environment based on the one or more instructions; wherein the infrastructure system is further configured to: aggregate a distance-based differential for each automated vehicle of a plurality of automated vehicles; generate a statistical distribution of an expected trajectory of each automated vehicle of the plurality of automated vehicles based on the aggregated distance-based differentials; and determine whether the distance-based differential exceeds the variation threshold for each automated vehicle of the plurality of automated vehicles based on the statistical distribution; and wherein the infrastructure system is further configured to: transmit an alert in response to an unsuccessful recalibration of the one or more sensors, wherein the alert is a service request.

The present disclosure provides one or more non-transitory computer-readable media storing processor-executable instructions that, when executed by at least one processor, cause the at least one processor to: identify a current trajectory of an automated vehicle based on a movement of the automated vehicle through a marshaling environment, wherein the current trajectory is based on a current location of the automated vehicle and a current speed of the automated vehicle; calculate a distance-based differential between the current trajectory of the automated vehicle and an expected trajectory of the automated vehicle, wherein the expected vehicle trajectory is based on a target path and a target vehicle speed; determine whether the distance-based differential exceeds a variation threshold; and recalibrate one or more sensors of an infrastructure system in response to the distance-based differential exceeding the variation threshold, wherein the recalibration of the one or more sensors is based on a vehicle perception analysis; wherein the at least one processor is further caused to: cause one or more sensors of the automated vehicle to be recalibrated in response to the distance-based differential exceeding the variation threshold; wherein the recalibration of the one or more sensors of the infrastructure system or the one or more sensors of the automated vehicle includes an intrinsic calibration, an extrinsic calibration, a color calibration, a frequency calibration, an angle calibration, a power calibration, or a combination thereof; wherein the vehicle perception analysis includes a field of vision analysis, a power analysis, a signal strength of reflected beams, an identification of one or more objects, distance measurements, detection accuracy, or a combination thereof; wherein the at least one processor is further caused to: transmit, to the automated vehicle, one or more instructions in response to the distance-based differential satisfying the variation threshold; and cause the automated vehicle to move from one workstation of the marshaling environment to another workstation of the marshaling environment based on the one or more instructions; wherein the at least one processor is further caused to: aggregate a distance-based differential for each automated vehicle of a plurality of automated vehicles; generate a statistical distribution of an expected trajectory of each automated vehicle of the plurality of automated vehicles based on the aggregated distance-based differentials; and determine whether the distance-based differential exceeds the variation threshold for each automated vehicle of the plurality of automated vehicles based on the statistical distribution; and wherein the at least one processor is further caused to: transmit an alert in response to an unsuccessful recalibration of the one or more sensors, wherein the alert is a service request.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIG. 3 is a flowchart illustrating an example method for monitoring and/or recalibrating one or more sensors associated with an automated vehicle and/or an infrastructure system in accordance with one or more embodiments of the present disclosure;

FIG. 4 is a flowchart illustrating another example method for monitoring and/or recalibrating one or more sensors associated with an automated vehicle and/or an infrastructure system in accordance with one or more embodiments of the present disclosure; and

FIG. 5 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provides a means for identifying one or more issues (e.g., performance issues and/or operational issues) associated with an infrastructure sensor suite and/or a vehicle sensor suite and recalibrating the infrastructure sensor suite and/or the vehicle sensor suite (e.g., recalibrating one or more sensors) based on one or more issues being identified. In one or more embodiments, the identification of issues and/or recalibration of the infrastructure sensor suite and/or the vehicle sensor suite based on communication between the infrastructure sensor suite and/or the vehicle sensor suite can be implemented in manufacturing processes without a human operator having to identify any issues with the infrastructure sensor suite and/or the vehicle sensor suite. In an instance where a large volume of vehicles is being manufactured, one or more embodiments thereby provide a more efficient and time-saving process with a more secure communication link between the infrastructure sensor suite and/or the vehicle sensor suite.

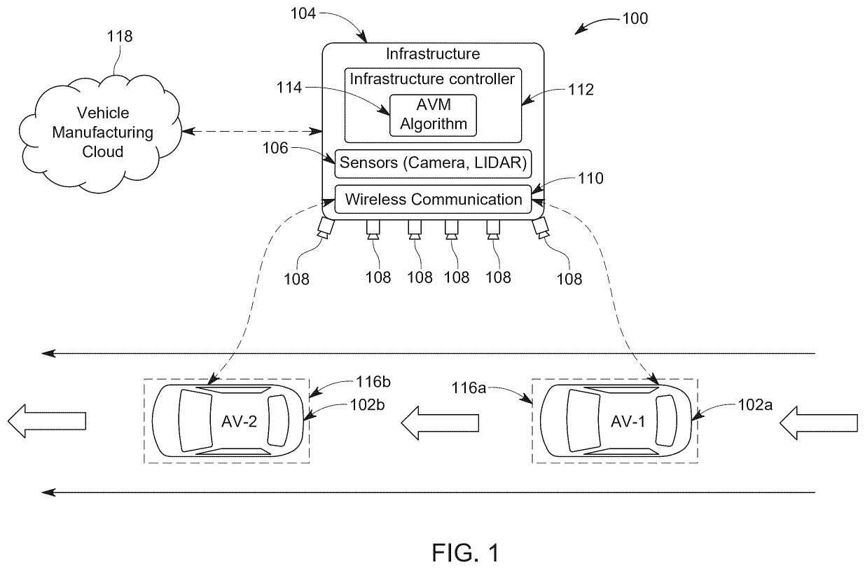

Referring now to FIG. 1, there is shown an automated vehicle marshaling (AVM) system 100 for maneuvering one or more automated and/or semi-automated vehicles 102 (e.g., one or more vehicles 102a, 102b) within a marshaling environment (e.g., a manufacturing facility or a parking lot). The AVM system 100 includes an infrastructure system 104. The infrastructure system 104 includes a sensor component 106 that communicates with a set of infrastructure sensors 108 such as, for example, one or more cameras, lidar, radar, and/or ultrasonic devices. The set of infrastructure sensors 108 is configured to monitor the movement of the vehicle(s) 102 as the vehicle(s) 102 moves through the marshaling environment. In one or more examples, the set of infrastructure sensors 108 is configured to utilize a shared global coordinate system for monitoring the movement of the vehicle(s) 102 as the vehicle(s) 102 moves through the marshaling environment. In one or more examples, the set of infrastructure sensors 108 is also configured to detect, identify, and/or verify behavior (e.g., operational characteristics or conditions) respective to each of the vehicles 102a, 102b as the vehicles 102a, 102b move through the marshaling environment, as is described herein.

The infrastructure system 104 also includes a wireless communication component 110 that provides for communication between the infrastructure system 104 and the vehicle(s) 102. Additionally, the infrastructure system 104 includes an infrastructure controller 112. The infrastructure controller 112 is configured to centrally control an operation of each of the vehicles 102a, 102b in a closed loop control system. However, it is understood that the infrastructure controller 112 is configured to centrally control an operation of each of the vehicles 102a, 102b within the functional and/or technical bounds of any system. For example, the operation of each of the vehicles 102a, 102b include propulsion, braking, and/or steering of the vehicle(s) 102. It is understood that the infrastructure controller 112 may be disposed within the infrastructure system 104 or externally located relative to the infrastructure system 104.

The infrastructure controller 112 includes an infrastructure-side AVM algorithm 114 (e.g., an AVM software module) that is configured to utilize one or more algorithmic learning models to perform a vehicle translation analysis and/or a vehicle perception analysis, as is described herein. It is understood that a vehicle-side AVM algorithm (e.g., a vehicle-side AVM algorithm 212) is also configured to utilize the one or more algorithmic learning models to support the vehicle translation analysis and/or the vehicle perception analysis performed by the infrastructure-side AVM algorithm 114. However, it is also understood that the vehicle-side AVM algorithm 212 is further configured to utilize the one or more algorithmic learning models to perform the vehicle translation analysis and/or the vehicle perception analysis itself (e.g., by the vehicle-side AVM algorithm 212). In one or more examples, the one or more algorithmic learning models can be dynamically trained (e.g., in real-time) via a supervised learning process or an unsupervised learning process. It is understood that the one or more algorithmic learning models can be a neural network model or any other type of learning model, for example. It is also understood that the infrastructure-side AVM algorithm 114 and/or the vehicle-side AVM algorithm 212 can execute the one or more algorithmic learning models to perform the vehicle translation analysis and/or the vehicle perception analysis respectively on each of the vehicles 102a, 102b.

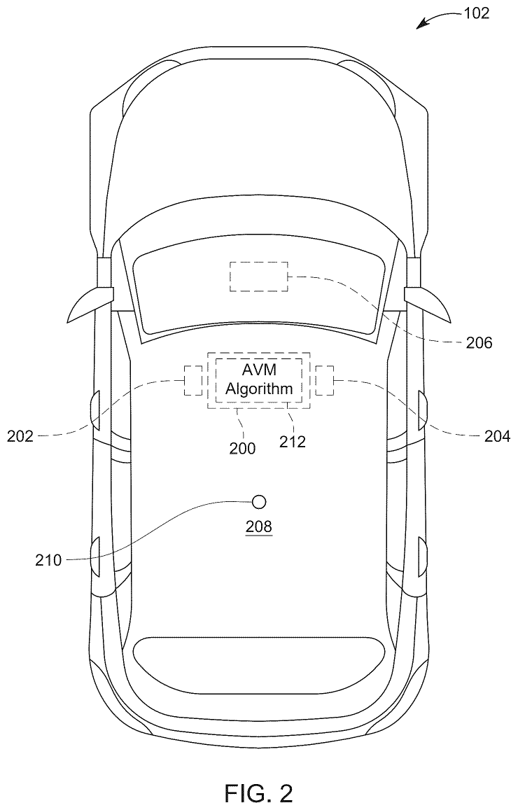

The infrastructure-side AVM algorithm 114 is also configured to facilitate communication between the infrastructure controller 112 and a vehicle controller (e.g., a vehicle controller 200 as shown in FIG. 2) associated with each of the vehicles 102a, 102b. In one or more examples, the communication between the infrastructure controller 112 and the vehicle controller 200 can be in the form of an exchange of one or more infrastructure marshaling messages and/or one or more vehicle marshaling messages.

In one or more embodiments, the infrastructure-side AVM algorithm 114 can execute the one or more algorithmic learning models to perform the vehicle translation analysis and/or the vehicle perception analysis respectively on each of the vehicles 102a, 102b based on the exchange of the one or more infrastructure marshaling messages and/or the one or more vehicle marshaling messages.

In one or more embodiments, the infrastructure system 104 is configured to store an expected behavior associated with any vehicle that is configured to move through the marshaling environment. For example, the expected behavior is stored in a database (not shown) associated with the infrastructure system 104. As another example, the database can be disposed internally or externally in relation to the infrastructure system 104. As an example, the expected behavior that is stored can represent historical data used as a basis by which the vehicle translation analysis and/or the vehicle perception analysis is performed. As another example, the expected behavior that is stored can relate to an expected behavior of a vehicle proximate to a particular workstation of one or more workstations associated with the marshaling environment.

In one or more embodiments, the infrastructure-side AVM algorithm 114 is further configured to perform one or more analyses to support the detection, identification, and/or verification of the behavior respective to each of the vehicles 102a, 102b. In one or more examples, the infrastructure-side AVM algorithm 114 is configured to verify the behavior respective to each of the vehicles 102a, 102b based on whether the identified behavior detected with respect to each of the vehicles 102a, 102b matches the expected behavior of the vehicle at a particular location within the marshaling environment.

In one or more embodiments, the one or more analyses used to support the detection, identification, and/or verification of the behavior respective to each of the vehicles 102a, 102b can also be used as a basis for performing the vehicle translation analysis. In one or more examples, the one or more analyses can compare a target path of each of the vehicles 102a, 102b and/or a target speed of each of the vehicles 102a, 102b with a current location of each of the vehicles 102a, 102b and/or a current speed of each of the vehicles 102a, 102b. As another example, the set of infrastructure sensors 108 is configured to monitor each of the vehicles 102a, 102b to determine the current location of each of the vehicles 102a, 102b and/or the current speed of each of the vehicles 102a, 102b. As yet another example, the set of infrastructure sensors 108 is configured to monitor any angle of each of the vehicles 102a, 102b such as, but not limited to, a front of each of the vehicles 102a, 102b, a back of each of the vehicles 102a, 102b, and/or one or more sides of each of the vehicles 102a, 102b. As a further example, the set of infrastructure sensors 108 is also configured to monitor a side-to-side positioning associated with each of the vehicles 102a, 102b, which can be a distance between a center of any vehicle (e.g., a reference point 210 as shown in FIG. 2) and a center of a particular driving lane the vehicle is moving about.

In one or more examples, the vehicle translation analysis can include a calculation of a distance-based differential between a current trajectory of each of the vehicles 102a, 102b and an expected trajectory of each of the vehicles 102a, 102b. It is understood that the expected trajectory of each of the vehicles 102a, 102b is based on the expected location of each of the vehicles 102a, 102b and/or the expected speed of each of the vehicles 102a, 102b. It is also understood that the current trajectory of each of the vehicles 102a, 102b is based on the current location of each of the vehicles 102a, 102b and/or the current speed of each of the vehicles 102a, 102b.

In one or more embodiments, the vehicle translation analysis can further include a generation (e.g., creation) of a statistical distribution of the expected trajectory of each of the vehicles 102a, 102b in real-time based on an aggregation of the distance-based differential specific to each of the vehicles 102a, 102b. As an example, the statistical distribution associated with each of the vehicles 102a, 102b is used as a basis for determining whether the distance-based differential specific to each of the vehicles 102a, 102b exceeds a variation threshold. For example, the variation threshold can represent a predefined range that is determined to be an acceptable distance-based differential without hindering movement of the vehicles 102a, 102b through the marshaling environment. It is understood that the predefined range can be any range based on any marshaling-related considerations or other considerations, for example.

In one or more embodiments, the vehicle translation analysis can be utilized to identify a vehicle positioning skew associated with the movement of each of the vehicles 102a, 102b over time as each of the vehicles 102a, 102b traverse (e.g., move across) the marshaling environment. In one or more examples, and in an instance wherein the vehicle(s) 102 is under complete control by the infrastructure system 104, or primary control by the infrastructure system 104, the vehicle translation analysis can be utilized to identify any issues with an infrastructure-based sensor suite. For example, the infrastructure-based sensor suite can include the set of infrastructure sensors 108 and/or any of the components within the infrastructure system 104 that support the set of infrastructure sensors 108 such as the infrastructure controller 112, the infrastructure-side AVM algorithm 114, the sensor component 106, and/or the wireless communication component 110. In one or more examples, and in an instance wherein the vehicle(s) 102 is under complete control by the vehicle itself (e.g., the vehicle(s) 102), or primary control by the vehicle itself, the vehicle translation analysis can be utilized to identify any issues with a vehicle sensor suite. For example, the vehicle-based sensor suite can include the plurality of on-board sensors 204 and/or any of the components within the vehicle(s) that support the plurality of on-board sensors 204 as is shown in FIG. 2, such as the vehicle controller 200, one or more actuators 202, a human machine interface (HMI) 206, a vehicle system 208, and/or the vehicle-side AVM algorithm 212.

In one or more embodiments, the vehicle translation analysis is further configured to determine one or more trends associated with varying sizes of vehicle groups moving across certain locations of the marshaling environment. In other words, the varying sizes of vehicle groups can constitute different sizes of groups of vehicles formed from a different number of vehicles in the different groups. As an example, the one or more trends can be determined based on historical data associated with moving averages of each vehicle group of the one or more preceding vehicle groups. As another example, the one or more determined trends can indicate a variation associated with the variation threshold. In other words, the one or more determined trends can indicate a higher than expected variation associated with the variation threshold or a lower than expected variation associated with the variation threshold, for example. As yet another example, the one or more determined trends can indicate variation-related biases associated with particular locations within the marshaling environment relative to the variation threshold. For example, the variation-related biases can include instances wherein vehicles may veer to a right direction or a left direction over time in moving through the particular location(s) within the marshaling environment.

In one or more examples, the vehicle perception analysis can include a field of vision analysis, a power analysis, a signal strength of reflected beams, an identification of one or more objects, distance measurements, detection accuracy, or a combination thereof. As another example, the vehicle perception analysis can be performed at any point in time and at any location within the marshaling environment as each of the vehicles 102a, 102b traverse the marshaling environment.

In one or more embodiments, the infrastructure-side AVM algorithm 114 can create a bounding box 116 (e.g., one or more bounding boxes 116a, 116b as shown in FIG. 1) associated with the vehicle(s) 102. As an example, the bounding box 116 (e.g., a virtual vehicle layout) bounds the vehicle(s) 102 within a matrix grid. As another example, and to the extent that more than one vehicle 102 is being marshaled by the infrastructure system 104, the bounding boxes 116a, 116b respectively bound each vehicle 102a, 102b. As a further example, the creation (e.g., generation) of the bounding box(es) 116 can aid in accurate marshaling of the vehicle(s) 102 through the marshaling environment and can thus support the operational functionality of the infrastructure sensor suite and/or the vehicle sensor suite.

In one or more embodiments, the AVM system 100 also includes a vehicle manufacturing cloud system 118 that can operate as the central cloud system that manages and/or facilitates the manufacturing process associated with the vehicle(s) 102 described herein. In one or more examples, the infrastructure system 104 is configured to wirelessly communicate with the vehicle manufacturing cloud system 118, and in some instances, the vehicle manufacturing cloud system 118 is configured to cause the infrastructure system 104 to monitor the progression of the vehicle(s) 102 as the vehicle(s) 102 progress through the marshaling environment.

Referring further to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally includes the vehicle controller 200, the one or more actuators 202, the plurality of on-board sensors 204, the HMI 206, and the vehicle system 208. The vehicle(s) 102 also has the reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint.

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programmed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for various communications on a vehicle communication network (not shown) that can include a bus in the vehicle(s) 102 such as a controller area network (CAN), or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between devices represented as the vehicle controller 200 in this disclosure. Further, as is discussed below, various other controllers and/or sensors provide data to the vehicle controller 200 via the vehicle communication network.

In addition, the vehicle controller 200, via a vehicle-side AVM algorithm 212, is configured for communicating through a vehicle-to-infrastructure communication network, such as identifying the trajectory of the vehicle(s) 102 relative to the target path of travel. It is understood that based on a level of assembly of the vehicle(s) 102, the movement of the vehicle(s) 102 may utilize the vehicle sensor suite to a lesser or fuller extent and thus will rely on the infrastructure sensor suite to move about the marshaling environment (e.g., via marshaling means).

The vehicle controller 200, via the vehicle-side AVM algorithm 212, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The vehicle actuators 202 are implemented via circuits, chips, or other electronic and/or mechanical components that can actuate various vehicle subsystems in accordance with appropriate control signals. The actuators 202 may be used to control braking, acceleration, and/or steering of the vehicle(s) 102. The vehicle controller 200 can be programmed to activate the vehicle actuators 202 including propulsion, steering, and/or braking based on the planned acceleration or deceleration of the vehicle(s) 102.

The plurality of on-board sensors 204 includes a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensor(s) affixed to one or more bumpers of the vehicle(s) 102 that may provide locations of the object(s) relative to the location of each of the vehicles 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be further programmed to determine a current vehicle location based on location coordinates (e.g., GPS coordinates) received from the vehicle(s) 102 indicative of a location of the vehicles 102 from a GPS sensor (not shown).

The HMI 206 is configured to receive information from the human operator during operation of the vehicle(s) 102. Moreover, the HMI 206 is configured to present information to the human operator, such as, an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

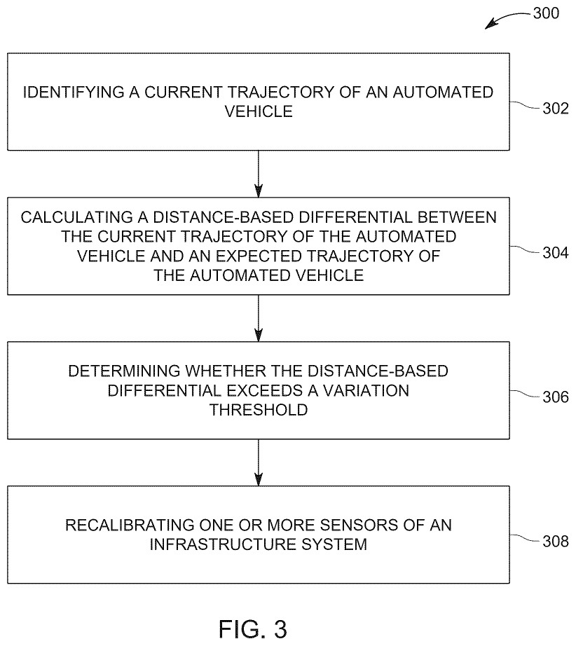

FIG. 3 is a flowchart illustrating an example method 300 for monitoring and/or recalibrating one or more sensors associated with an automated vehicle (e.g., the vehicle 102) and/or an infrastructure system (e.g., the infrastructure system 104). At operation 302, a current trajectory of the automated vehicle is identified. For example, the current trajectory of the automated vehicle is identified based on a movement of the automated vehicle through a marshaling environment. As another example, the current trajectory is based on a current location of the automated vehicle and/or a current speed of the automated vehicle. As yet another example, the identification of the current trajectory of the automated vehicles is made by the infrastructure system.

At operation 304, a distance-based differential between the current trajectory of the automated vehicle and an expected trajectory of the automated vehicle is calculated. For example, the expected vehicle trajectory is based on a target path of the automated vehicle and a target speed of the automated vehicle. At operation 306, a determination is made regarding whether the distance-based differential exceeds a variation threshold (e.g., a distance variation limit).

At operation 308, one or more sensors (e.g., the set of infrastructure sensors 108) of the infrastructure system is recalibrated in response to the distance-based differential exceeding the variation threshold. For example, the recalibration of the one or more sensors is based on a vehicle perception analysis. In one or more embodiments, the infrastructure system is configured to cause one or more sensors (e.g., the plurality of on-board sensors 204) of the automated vehicle to be recalibrated. In one or more examples, the infrastructure system is configured to cause the one or more sensors of the automated vehicle to be recalibrated in response to the distance-based differential exceeding the variation threshold. For example, the recalibration of the one or more sensors of the infrastructure system and/or the one or more sensors of the automated vehicle includes an intrinsic calibration, an extrinsic calibration, a color calibration, a frequency calibration, an angle calibration, a power calibration, or a combination thereof. As yet another example, the vehicle perception analysis includes a field of vision analysis, a power analysis, a signal strength of reflected beams, an identification of one or more objects, distance measurements, detection accuracy, or a combination thereof.

In one or more embodiments, the infrastructure system is configured to transmit one or more instructions to the automated vehicle. For example, the transmission of the one or more instructions is made in response to the distance-based differential satisfying the variation threshold. The infrastructure system is further configured to cause the automated vehicle to move from one workstation of the marshaling environment to another workstation of the marshaling environment based on the one or more instructions. In one or more embodiments, the infrastructure system is configured to transmit an alert in response to an unsuccessful recalibration of the one or more sensors. For example, the alert is a service request. However, it is understood that the alert can by any type of request associated with a functionality related to the automated vehicle and/or the infrastructure system.

In one or more embodiments, the infrastructure system is configured to aggregate a distance-based differential for each automated vehicle of a plurality of automated vehicles. The infrastructure system is also configured to generate a statistical distribution of an expected trajectory of each automated vehicle of the plurality of automated vehicles. For example, the generation of the statistical distribution of the expected trajectory of each automated vehicle of the plurality of automated vehicles is based on the aggregated distance-based differentials. The infrastructure system is further configured to determine whether the distance-based differential exceeds the variation threshold for each automated vehicle of the plurality of automated vehicles. For example, the determination regarding whether the distance-based differential exceeds the variation threshold for each automated vehicle of the plurality of automated vehicles is based on the statistical distribution.

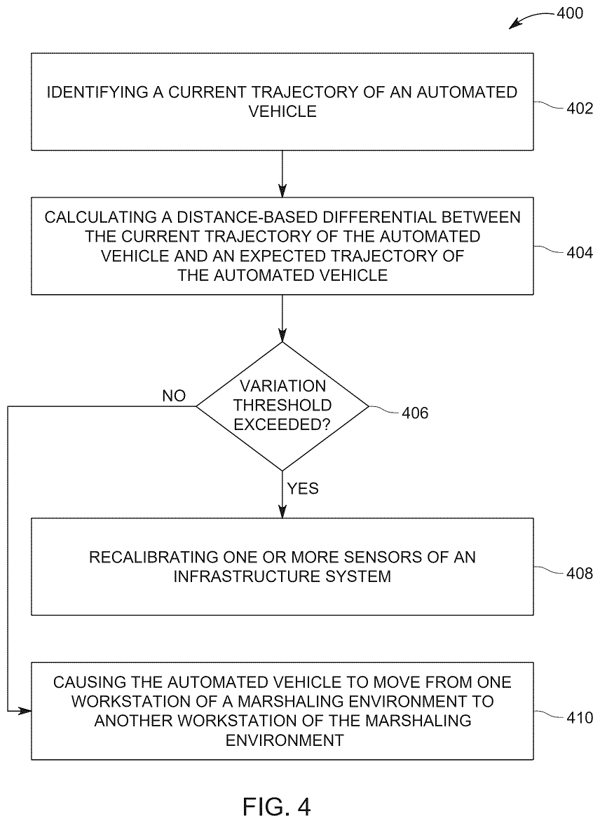

FIG. 4 is a flowchart illustrating another example method 400 for monitoring and/or recalibrating one or more sensors associated with an automated vehicle (e.g., the vehicle 102) and/or an infrastructure system (e.g., the infrastructure system 104). At operation 402, a current trajectory of the automated vehicle is identified. For example, the current trajectory of the automated vehicle is identified based on a movement of the automated vehicle through a marshaling environment. As another example, the current trajectory is based on a current location of the automated vehicle and/or a current speed of the automated vehicle. As yet another example, the identification of the current trajectory of the automated vehicles is made by the infrastructure system. At operation 404, a distance-based differential between the current trajectory of the automated vehicle and an expected trajectory of the automated vehicle is calculated. For example, the expected vehicle trajectory is based on a target path of the automated vehicle and a target speed of the automated vehicle.

At operation 406, a determination is made regarding whether the distance-based differential exceeds a variation threshold. In one or more examples, and in an instance wherein a determination is made that the distance-based differential exceeds the variation threshold, one or more sensors (e.g., the set of infrastructure sensors 108) of the infrastructure system is recalibrated at operation 408 in response to the distance-based differential exceeding the variation threshold. For example, the recalibration of the one or more sensors is based on a vehicle perception analysis. As another example, the recalibration of the one or more sensors of the infrastructure system includes an intrinsic calibration, an extrinsic calibration, a color calibration, a frequency calibration, an angle calibration, a power calibration, or a combination thereof. As yet another example, the vehicle perception analysis includes a field of vision analysis, a power analysis, a signal strength of reflected beams, an identification of one or more objects, distance measurements, detection accuracy, or a combination thereof.

In one or more examples, a determination that the distance-based differential exceeds the variation threshold can indicate abnormal functionality associated with the operational behavior of the infrastructure sensor suite and/or the vehicle sensor suite. As an example, the infrastructure system 104 is configured to then transmit one or more operational commands to a relevant sensor suite system (e.g., another infrastructure sensor suite and/or the vehicle sensor suite) to dynamically identify, verify, and/or diagnose an issue affecting the infrastructure sensor suite and/or the vehicle sensor suite in real-time. In one or more examples, sensor recalibration for the infrastructure sensor suite and/or the vehicle sensor suite can occur in a closed loop system. However, it is understood that the sensor recalibration for the infrastructure sensor suite and/or the vehicle sensor suite can occur within the functional and/or technical bounds of any system. For example, the sensor recalibration can include camera calibration, radar calibration, among others. As another example, the camera calibration can include intrinsic calibration associated with internal parameters of the camera, extrinsic calibration associated with a field of view related to the orientation of the camera, and/or color calibration. As yet another example, the radar calibration can include frequency calibration, angle calibration, and/or power calibration.

However, in other examples, and in an instance wherein a determination is made at operation 406 that the distance-based differential does not exceed the variation threshold, the infrastructure system is configured to cause the automated vehicle to move from one workstation of the marshaling environment to another workstation of the marshaling environment at operation 410. For example, the automated vehicle is caused to move from one workstation of the marshaling environment to another workstation of the marshaling environment based on one or more instructions. As another example, the infrastructure system is configured to transmit the one or more instructions to the automated vehicle. As yet another example, the transmission of the one or more instructions is made in response to the distance-based differential satisfying (not exceeding) the variation threshold. In one or more examples, the determination made that the distance-based differential does not exceed the variation threshold can indicate that the infrastructure sensor suite and/or the vehicle sensor suite are outputting sensor data within an expected variation, and thus no remedial actions are necessary to be performed.

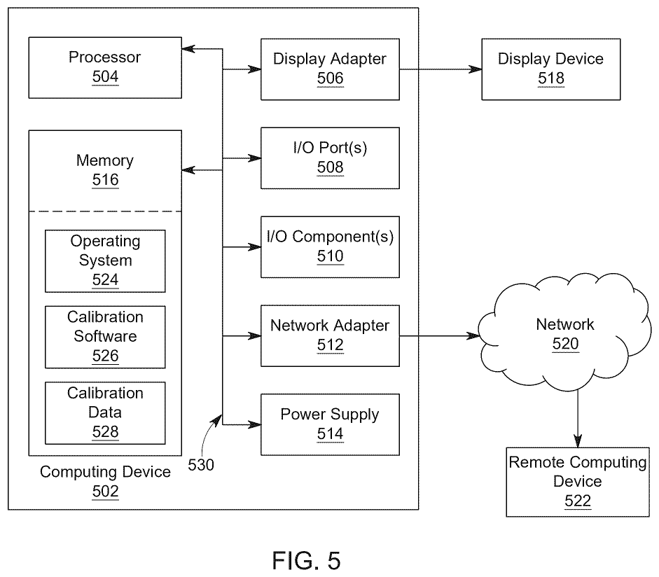

FIG. 5 illustrates an operating environment, such as a computer system, that facilitates the performance of the one or more systems and methods described herein. More specifically, the systems and methods described herein can be implemented using a computing device 502. For example, the computing device 502 can be a personal computer, a desktop, a laptop, a tablet, a hand-held computer, a server, a workstation, a mainframe, a wearable computer, a supercomputer, or a combination thereof. However, it is understood that the aforementioned examples of the computing device 502 is non-exhaustive and the computing device 502 can be any type of processing or computing device. The computing device 502 generally includes a processor 504, a display adapter 506, one or more input/output port(s) 508, one or more input/output component(s) 510, a network adapter 512, a power supply 514, and a memory 516. However, it is understood that the computing device 502 can include any additional components therein and is not required to include any of the listed components (e.g., the processor 504, the display adapter 506, the one or more input/output port(s) 508, the one or more input/output component(s) 510, the network adapter 512, the power supply 514, and the memory 516).

The processor 504 is configured to provide instructions to the computing device 502 so that the computing device 502 can process one or more tasks including the implementation of a software program to perform one or more operations as described in more detail herein. It is also understood that the computing device 502 may include any number or processors 504 therein. The display adapter 506 can be a graphics card or a video board that provides the computing device 502 with a capability to display content on a display device 518. For example, the display device 518 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 518 is non-exhaustive and that the display device 518 can be any type of device capable of providing a visual display.

The input/output port(s) 508 provide a number of interfaces (e.g., sockets) for one or more cables to connect to the computing device 502. It is understood that there may be any number of input/output port(s) 508 on the computing device 502. For example, the input/output port(s) 508 provides a means for the computing device 502 to receive signals and/or data from an external device connected to the computing device 502 via the one or more cables. As another example, the input/output port(s) 508 provide a means for the computing device 502 to send signals and/or data to an external device connected to the computing device 502 via the one or more cables. The input/output component(s) 510 can include one or more components that support the input/output port(s) 508 such as, but not limited to, a switch, a push button, a pressure mat, a float switch, a keypad, a radio receive, or a combination thereof.

The network adapter 512 can be any type of network interface controller that is configured to provide a means for communicating over a network 520 with another computing device, such as a remote computing device 522. For example, the remote computing device 522 can be a user device such as a cellular-phone, a smartphone, a tablet, a laptop, or a combination thereof. The power supply 514 is configured to convert alternating high voltage current (e.g., AC) into direct current (e.g., DC) to provide power to the other components (e.g., the processor 504, the display adapter 506, the one or more input/output port(s) 508, the one or more input/output component(s) 510, the network adapter 512, and the memory 516) of the computing device 502.

Additionally, the memory 516 can be a mass storage device and/or a system memory such as a hard disk drive, a memory card, a solid-state drive, random access memory (RAM), or a combination thereof. The memory 516 is configured to provide storage for instructions and data associated with the operation of the computing device 502. The memory 516 can generally include an operating system 524, calibration software 526, and calibration data 528. For example, the operating system 524 is configured to manage and/or process any of the data and/or instructions associated with the calibration software 526 and/or calibration data 528, as described in more detail herein.

Furthermore, a system bus 530 is also included within the computing device 502 that is configured to couple each of the various components (e.g., the processor 504, the display adapter 506, the one or more input/output port(s) 508, the one or more input/output component(s) 510, the network adapter 512, the power supply 514, and the memory 516) of the computing device 502. It is also understood that each of the components of the computing device 502, and the functionality associated with each of the components of the computing device 502, may be implemented within the remote computing device 522. While the operating environment illustrated within FIG. 5 depicts a particular configuration associated with at least the computing device 502, the network 520, and the remote computing device 522, it is understood that the operating environment may be configured in any way.

Thus, one or more examples of the present disclosure provides a means for monitoring an infrastructure sensor suite and/or a vehicle sensor suite based on an exchange of one or more messages between the infrastructure sensor suite and/or the vehicle sensor suite. The present disclosure also provides a means for recalibrating the infrastructure sensor suite and/or the vehicle sensor suite based on a detection of one or more issues with either of the infrastructure sensor suite and/or the vehicle sensor suite.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
identifying a current trajectory of an automated vehicle based on a movement of the automated vehicle through a marshaling environment, wherein the current trajectory is based on a current location of the automated vehicle and a current speed of the automated vehicle;
calculating a distance-based differential between the current trajectory of the automated vehicle and an expected trajectory of the automated vehicle, wherein the expected vehicle trajectory is based on a target path of the automated vehicle and a target speed of the automated vehicle;
determining whether the distance-based differential exceeds a variation threshold; and
recalibrating one or more sensors of an infrastructure system in response to the distance-based differential exceeding the variation threshold, wherein the recalibration of the one or more sensors is based on a vehicle perception analysis.

2. The method of claim 1, further comprising:
causing one or more sensors of the automated vehicle to be recalibrated in response to the distance-based differential exceeding the variation threshold.

3. The method of claim 2, wherein the recalibration of the one or more sensors of the infrastructure system or the one or more sensors of the automated vehicle includes an intrinsic calibration, an extrinsic calibration, a color calibration, a frequency calibration, an angle calibration, a power calibration, or a combination thereof.

4. The method of claim 2, wherein the vehicle perception analysis includes a field of vision analysis, a power analysis, a signal strength of reflected beams, an identification of one or more objects, distance measurements, detection accuracy, or a combination thereof.

5. The method of claim 1, further comprising:
transmitting, to the automated vehicle, one or more instructions in response to the distance-based differential satisfying the variation threshold; and
causing the automated vehicle to move from one workstation of the marshaling environment to another workstation of the marshaling environment based on the one or more instructions.

6. The method of claim 1, further comprising:
aggregating a distance-based differential for each automated vehicle of a plurality of automated vehicles;
generating a statistical distribution of an expected trajectory of each automated vehicle of the plurality of automated vehicles based on the aggregated distance-based differentials; and
determining whether the distance-based differential exceeds the variation threshold for each automated vehicle of the plurality of automated vehicles based on the statistical distribution.

7. The method of claim 1, further comprising:
transmitting an alert in response to an unsuccessful recalibration of the one or more sensors, wherein the alert is a service request.

8. A system comprising:
an infrastructure system configured to:
identify a current trajectory of an automated vehicle based on a movement of the automated vehicle through a marshaling environment, wherein the current trajectory is based on a current location of the automated vehicle and a current speed of the automated vehicle,
calculate a distance-based differential between the current trajectory of the automated vehicle and an expected trajectory of the automated vehicle, wherein the expected vehicle trajectory is based on a target path and a target vehicle speed,
determine whether the distance-based differential exceeds a variation threshold, and
recalibrate one or more sensors of the infrastructure system in response to the distance-based differential exceeding the variation threshold, wherein the recalibration of the one or more sensors is based on a vehicle perception analysis; and
the automated vehicle configured to:
recalibrate one or more sensors of the automated vehicle in response to the distance-based differential exceeding the variation threshold.

9. The system of claim 8, wherein the recalibration of the one or more sensors of the infrastructure system or the one or more sensors of the automated vehicle includes an intrinsic calibration, an extrinsic calibration, a color calibration, a frequency calibration, an angle calibration, a power calibration, or a combination thereof.

10. The system of claim 8, wherein the vehicle perception analysis includes a field of vision analysis, a power analysis, a signal strength of reflected beams, an identification of one or more objects, distance measurements, detection accuracy, or a combination thereof.

11. The system of claim 8, wherein the infrastructure system is further configured to:
transmit, to the automated vehicle, one or more instructions in response to the distance-based differential satisfying the variation threshold; and
cause the automated vehicle to move from one workstation of the marshaling environment to another workstation of the marshaling environment based on the one or more instructions.

12. The system of claim 9, wherein the infrastructure system is further configured to:
aggregate a distance-based differential for each automated vehicle of a plurality of automated vehicles;
generate a statistical distribution of an expected trajectory of each automated vehicle of the plurality of automated vehicles based on the aggregated distance-based differentials; and
determine whether the distance-based differential exceeds the variation threshold for each automated vehicle of the plurality of automated vehicles based on the statistical distribution.

13. The system of claim 9, wherein the infrastructure system is further configured to:
transmit an alert in response to an unsuccessful recalibration of the one or more sensors, wherein the alert is a service request.

14. One or more non-transitory computer-readable media storing processor-executable instructions that, when executed by at least one processor, cause the at least one processor to:
identify a current trajectory of an automated vehicle based on a movement of the automated vehicle through a marshaling environment, wherein the current trajectory is based on a current location of the automated vehicle and a current speed of the automated vehicle;
calculate a distance-based differential between the current trajectory of the automated vehicle and an expected trajectory of the automated vehicle, wherein the expected vehicle trajectory is based on a target path and a target vehicle speed;
determine whether the distance-based differential exceeds a variation threshold; and
recalibrate one or more sensors of an infrastructure system in response to the distance-based differential exceeding the variation threshold, wherein the recalibration of the one or more sensors is based on a vehicle perception analysis.

15. The one or more non-transitory computer-readable media of claim 14, wherein the at least one processor is further caused to:
cause one or more sensors of the automated vehicle to be recalibrated in response to the distance-based differential exceeding the variation threshold.

16. The one or more non-transitory computer-readable media of claim 15, wherein the recalibration of the one or more sensors of the infrastructure system or the one or more sensors of the automated vehicle includes an intrinsic calibration, an extrinsic calibration, a color calibration, a frequency calibration, an angle calibration, a power calibration, or a combination thereof.

17. The one or more non-transitory computer-readable media of claim 15, wherein the vehicle perception analysis includes a field of vision analysis, a power analysis, a signal strength of reflected beams, an identification of one or more objects, distance measurements, detection accuracy, or a combination thereof.

18. The one or more non-transitory computer-readable media of claim 14, wherein the at least one processor is further caused to:
transmit, to the automated vehicle, one or more instructions in response to the distance-based differential satisfying the variation threshold; and
cause the automated vehicle to move from one workstation of the marshaling environment to another workstation of the marshaling environment based on the one or more instructions.

19. The one or more non-transitory computer-readable media of claim 14, wherein the at least one processor is further caused to:
aggregate a distance-based differential for each automated vehicle of a plurality of automated vehicles;
generate a statistical distribution of an expected trajectory of each automated vehicle of the plurality of automated vehicles based on the aggregated distance-based differentials; and
determine whether the distance-based differential exceeds the variation threshold for each automated vehicle of the plurality of automated vehicles based on the statistical distribution.

20. The one or more non-transitory computer-readable media of claim 14, wherein the at least one processor is further caused to:
transmit an alert in response to an unsuccessful recalibration of the one or more sensors, wherein the alert is a service request.
